(19) United States
(12) Patent Application Publication
(10) Pub. No.: US 2014/0258000 A1
(43) Pub. Date: Sep. 11, 2014

(54) DYNAMIC FLOOR PRICING SYSTEM AND ASSOCIATED METHODS

(71) Applicant: CONTECH HOLDINGS, LLC, Winter Park, FL (US)

(72) Inventors: Michael Connolly, Winterpark, FL (US); Nathaniel Thomas, Winterpark, FL (US)

(73) Assignee: CONTECH HOLDINGS, LLC, Winter Park, FL (US)

(21) Appl. No.: 14/199,613

(22) Filed: Mar. 6, 2014

Related U.S. Application Data
(60) Provisional application No. 61/773,184, filed on Mar. 6, 2013.

(51) Int. Cl. G06Q 30/02

(52) U.S. Cl. CPC G06Q 30/0275
USPC 705/14.71

(57) ABSTRACT

A computer-implemented method for increasing publisher revenue for targeted online advertising includes retrieving buying data from an ad network report. Ad impression counts and bid amounts from winning bids may be used to determine a true cost per thousand impressions (CPM) value of an ad request. Price floors for the ad request may be set to equal the true CPM value either automatically or manually by the publisher. Monitoring periods for purchase data reporting from participating ad networks may provide true CPM values in real-time.

### RELATED APPLICATIONS

This application claims the benefit under 35 U.S.C. §119(e) of U.S. Provisional Patent Application Ser. No. 61/773,184 filed by the inventors of the present application on Mar. 6, 2013, and titled Dynamic Floor Pricing System And Associated Methods, the entire content of which is incorporated herein by reference.

### FIELD OF THE INVENTION

The present invention relates to the field of online ad serving and, more specifically, to pricing publisher inventory for real-time bidding, and associated systems and methods.

### BACKGROUND OF THE INVENTION

Real-time bidding (RTB) is a sales channel in which a publisher of online content, such as a website, may place an ad request to fill available ad space complementary to that content. An ad impression may be defined as a single instance of an ad appearing on a website (i.e., a person sees the advertisement). An advertiser may define an ad campaign to include a number of ad impressions sought and a monetary amount budgeted to purchase the desired impressions. Multiple advertisers, in pursuit of their respective ad campaigns, may place auction-style bids on desired ad impressions, with the targeted ad impression going to the highest bidder. Real-time bids submitted by the multiple advertisers are considered not only against one other, but also against other conditions of the ad request, such as a price floor (also called a reserve price) below which a publisher will not sell a particular ad space. The automated processing of these and other conditions precedent to completing the RTB transaction takes place in milliseconds, resulting in ad delivery that appears to a target consumer to occur instantaneously.

The real-time bidding sales model has the potential to give publishers access to more advertising demand sources and, consequently, to increase publisher revenue. However, current RTB technology tends to favor the interests of advertisers over those of publishers. For example, many RTB auctions are “second price” auctions, which means the winning bidder pays slightly more than the next highest bidder's offer. Allowing advertisers to reach their target consumers at the lowest possible price using a second price auction creates downward pricing pressure that may negatively impact publisher revenue. A publisher may attempt to protect against this downward pricing pressure by setting a price floor. Unfortunately, setting price floors too high may turn away buyers at the risk of not finding another buyer later, and therefore potentially may compromise publisher revenue even more.

Real-time bidding automation may present an opportunity for publishers to improve decision support by retrieving and analyzing information collected during the evaluation of an ad impression by several prospective buyers. Specifically, historical data gathered during an auction from all bidders (not just the winning bidder) may be captured by the publisher and used in pricing determination during future auctions. Various approaches to using such analysis to allow publishers to set prices and, more specifically, to establish price floors exist in the art.

U.S. Patent Application No. 2010/0241511 by Cunningham et al. discloses a system for establishing a reserve price for a publisher's ad space inventory by redirecting a certain percentage of ad request traffic to external markets for processing. The performance of these redirected ad requests may be analyzed to determine a winning bid (otherwise known as a clearing price) that may be used as a price floor. However, the reference does not disclose optimization of price floors using historical data generated entirely within a real-time bidding market comprising participating advertisers.

U.S. Pat. No. 8,280,765 to Barr et al. discloses setting a minimum bid value for an ad impression based on a ratio of guaranteed (premium) ad impressions to expected remaining (auctioned) ad impressions. If a publisher does not have any guaranteed revenue-generating ads to place if a price floor is not met, the Barr implementation may track bid values of ad impressions over a period of time and adjust the minimum value requested for the ad impression based on either tracking data (e.g., trailing average cost per thousand impressions (CPM)) or external data (e.g., seasonal historical values, industry-wide ad purchase data). However, the disclosed implementation does not address decision-support functionality to allow a publisher to choose between automated and manual floor price setting.

U.S. Published Patent Application No. 2011/0040636 by Simmons et al. discloses selecting and presenting to a publisher an anticipated economic valuation for each potential placement for an advertisement. The anticipated economic valuation may be based at least in part on advertiser data, historical event data, user data, real-time event data, contextual data or third-party commercial data. However, like the Barr reference, the disclosed implementation does not address decision-support functionality to allow a publisher to choose between automated and manual floor price setting.

There exists a need to determine price floors at which publisher revenue is maximized, and to empower a publisher to dynamically set price floors for ad space inventory in response to changes in demand. This background information is provided to reveal information believed by the applicant to be of possible relevance to the present invention. No admission is necessarily intended, nor should be construed, that any of the preceding information constitutes prior art against the present invention.

### SUMMARY OF THE INVENTION

With the foregoing in mind, it is therefore an object of embodiments of the present invention to provide a dynamic floor pricing system (DFPS) and associated methods to support setting of individual floor prices for multiple ad impressions based on certain criteria such as geographic location and impression limits. The DFPS may comprise aggregation technology to dynamically update multiple price floors based on the third-party ad network responses to publisher ad requests. The system may communicate with these ad networks directly to retrieve the current cost per thousand impressions (CPM) from each ad network and to display that price to the publisher, who either may manually apply the ad network's CPM as the new price floor value or may set the update of the price floor to match the ad network CPM to occur automatically.

The present invention may advantageously allow a publisher to use dynamic floor pricing to leverage real-time bidding across multiple bid ranges, simultaneously, and therefore increase overall publisher revenue. The DFPS also may advantageously represent the true CPM that a third-party ad network is providing, which may equip a publisher to make price floor decisions that cause the real-time bidding process to generate more accurate bids against ad impressions. Because the reserve price below which the publisher will not sell an ad impression may be based largely on what other third-party add networks are reporting to the publisher, real-time bids routinely may be compared against a true price floor.

These and other objects, features, and advantages in accordance with the present invention are provided by a computer-implemented method for increasing publisher revenue for targeted online advertising. The method may include retrieving from one or more ad networks a report containing buying event data. For example, and without limitation, the buying report may include real-time bidding (RTB) event data related to the purchase of an ad impression, which may include ad purchase amounts from winning bids. Retrieval of a buying report may be triggered at the end of a monitoring period.

The method may also include determining a true cost per thousand impressions (CPM) value using bid amounts and an ad impression count retrieved from the buying report. For example, and without limitation, the true CPM value may be determined by averaging the retrieved bid amounts. Also for example, and without limitation, the true CPM value may be set to a winning bid amount. For example, and without limitation, the ad impression count may be a tally of all purchase event records retrieved from the buying report, or a tally of monetized purchase event records from the buying report.

The method may further include setting one or more price floors for an ad request, each price floor set to equal the true CPM value associated with the respective ad network. Updating the price floor of the ad request to equal the true CPM value may occur automatically. Alternatively, manual updating of the price floor of the ad request to equal the true CPM value may comprise displaying the true CPM value, and receiving a command to apply the true CPM value.

The above-listed objects, features, and advantages according to the present invention are further provided by a dynamic floor pricing system operable to link price floors to third-party ad networks to create a fluctuating price floor representing a more accurate approximation of the value of an ad impression in real time. The DFPS according to an embodiment of the present invention may include a publisher server and a publisher workstation. The publisher server may comprise a publishing processor and a publishing database. The publisher workstation may comprise a system interface that may operate to access a DFPS client and a sell-side RTB client. The publisher server and publisher workstation may be configured in data communication with each other using a network, such as the Internet. The publisher server and publisher workstation may also use this network to communicate with third-party resources that collectively may represent a real-time bidding environment, including an exchange server, one or more ad network servers, advertiser workstations, and remote computing devices employed by users who may be targeted by advertisers.

The system interface of the publisher workstation, according to an embodiment of the present invention, may allow a publisher to control floor prices for each ad network, as well as to set impression limits and other requirements per floor level. The system interface may present this information graphically to the publisher in an intuitive top-to-bottom presentation format, with higher floor prices positioned nearer the top. Directly adjacent to each floor price may be the ad network associated to the floor price, and the true CPM value established using bid data retrieved from that ad network for the subject ad impression. The true CPM value advantageously may be compared to the price floor currently set for the ad impression, allowing the publisher either to adjust this value to the true CPM value manually or to allow the system to update the price floor to the true CPM value automatically.

### BRIEF DESCRIPTION OF THE DRAWINGS

FIG. 1 is a block diagram illustrating a dynamic floor pricing system (DFPS) for use in a real-time bidding environment according to an embodiment of the present invention.

FIG. 2 is a flowchart illustrating a process of determining a real-time cost per thousand impressions (CPM) reported by an ad network using the DFPS of FIG. 1.

FIG. 3 is a flowchart illustrating a process of selecting a price floor based on input from an ad network using the DFPS of FIG. 1.

FIG. 4 is a diagram illustrating a user interface during display of dynamic floor pricing management functionality as implemented by the DFPS of FIG. 1.

FIG. 5 is a diagram illustrating a mobile device used to display the user interface illustrated in FIG. 4.

FIG. 6 is a block diagram representation of a machine in the example form of a computer system according to an embodiment of the present invention.

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Those of ordinary skill in the art will realize that the following embodiments of the present invention are only illustrative and are not intended to be limiting in any way. Other embodiments of the present invention will readily suggest themselves to such skilled persons having the benefit of this disclosure. Like numbers refer to like elements throughout.

Although the following detailed description contains many specifics for the purposes of illustration, anyone of ordinary skill in the art will appreciate that many variations and alterations to the following details are within the scope of the invention. Accordingly, the following embodiments of the invention are set forth without any loss of generality to, and without imposing limitations upon, the claimed invention.

Furthermore, in this detailed description, a person skilled in the art should note that quantitative qualifying terms such as “generally,” “substantially,” “mostly,” and other terms are used, in general, to mean that the referred to object, characteristic, or quality constitutes a majority of the subject of the reference. The meaning of any of these terms is dependent upon the context within which it is used, and the meaning may be expressly modified.

In this detailed description of the present invention, a person skilled in the art should note that directional terms, such as “above,” “below,” “upper,” “lower,” and other like terms are used for the convenience of the reader in reference to the drawings. Also, a person skilled in the art should notice this description may contain other terminology to convey position, orientation, and direction without departing from the principles of the present invention.

In the interest of clarity, not all of the routine features of the implementations described herein are shown and described. It will, of course, be appreciated that in the development of such features, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

Example methods and systems for selecting dynamic floor prices are described herein below. In the following description, for purposes of explanation, numerous specific details are set forth to provide a thorough understanding of example embodiments. It will be evident, however, to one of ordinary skill in the art that the present invention may be practiced without these specific details and/or with different combinations of the details than are given here. Thus, specific embodiments are given for the purpose of simplified explanation and not limitation. Some of the illustrative aspects of the present invention may be advantageous in solving the problems herein described and other problems not discussed which are discoverable by a skilled artisan.

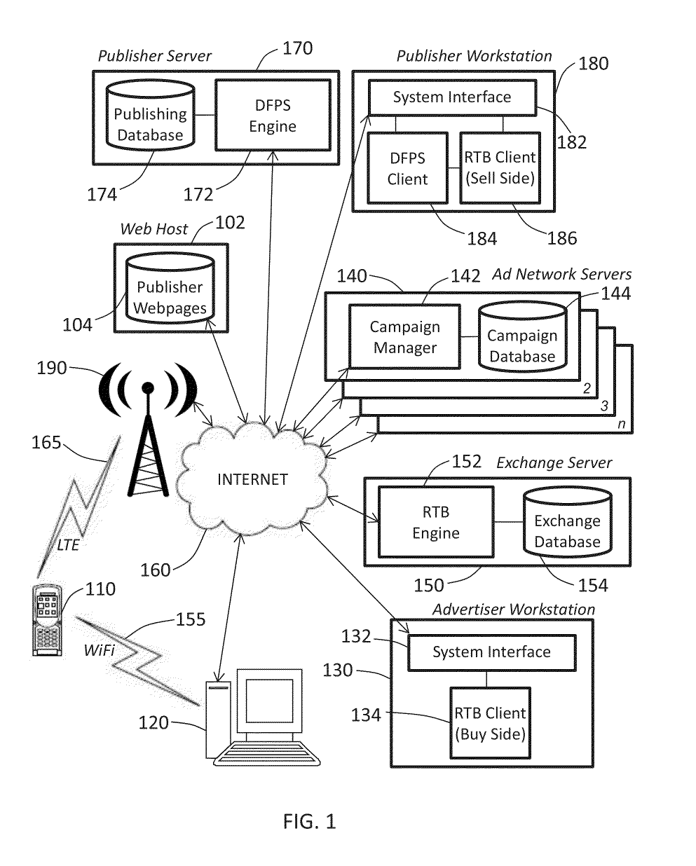

Referring now to FIGS. 1-6, systems and methods for dynamically determining and selecting floor pricing in a real-time bidding scenario according to an embodiment of the present invention are now described in greater detail. Throughout this disclosure, the present invention may be referred to as a dynamic floor pricing system, a DFPS, a computer program product, a computer program, a product, a system, a tool, and a method. Those skilled in the art will appreciate that this terminology does not affect the scope of the invention as outlined herein.

In the following disclosure, the present invention may be referred to as relating to adverts, advertisements, marketing campaigns, unsolicited content, and ads. Those skilled in the art will appreciate that this terminology is only illustrative and does not affect the scope of the invention. For instance, the present invention may just as easily relate to electronic coupons, political messages, public service announcements, or informational broadcasts.

Referring initially to FIG. 1, a real-time bidding (RTB) environment may be employed to deliver and display paid advertisements when a user of a computerized device navigates electronically to a publisher's website. A publisher may employ a web host 102 to store webpages 104 comprising the publisher's website that the visiting user sees. The data store holding the publisher webpages 104 may include digital information in the form of primary content (e.g., the publisher's website) and also of complementary content, such as advertisements, pictures, figures, text, videos, audio recordings or any other digital content. The user's computerized device may be a mobile device 110, such as a cell phone, smart phone, notebook computer, a tablet personal computer (PC), or a personal digital assistant (PDA). Alternatively, the user's computerized device may be a desktop computer 120 or a laptop computer.

The RTB environment may further comprise advertiser workstations 130 and ad network servers 140 in data communication with an exchange server 150 via a network 160. Prospective advertisers may use the system interfaces 132 of advertiser workstations 130 to access a buy-side RTB client 134. The buy-side RTB client 134 may allow an advertiser to participate in real-time bidding for desired ad impressions. More specifically, advertisers may use the real-time bidding (RTB) client to bid on ad space, rather than pay the publisher's set price for the ad space.

The exchange server 150 may comprise a real-time bidding (RTB) engine 152 that may manage calls to one or more ad network servers 140 (also known as Demand Side Platforms or Ad Exchanges) to determine which of several competing advertisers gets to serve an ad to a publisher's webpages 104. The computer-programmed instructions that may constitute the RTB engine 152 and/or the transaction data manipulated during the RTB process may be stored to and retrieved from an exchange database 154. The exchange server 152 may execute the RTB engine 152 to determine which ad networks should be exposed to a publisher's ad request, and may create a request package for each ad network server 140 containing information the campaign manager 142 needs to make a bidding decision. For example, and without limitation, a set of attributes associated with each user of a computerized device 110, 120 may be transferred from the exchange server 1150 to an ad network server 140.

Ad network servers 140 each may comprise a campaign manager 142 that may manipulate advertising data stored in a campaign database 144. Each ad network server may respond uniquely to individual purchaser ad requests by applying some form of business rule in real-time to decide which campaign to bid with and at what price. For example, the campaign manager 142 may determine whether the user has the desired attributes (recorded, for example, as cookies containing user identification data) that an advertiser desires in a target consumer. Data representing the user's actual attributes and also the advertiser's desired attributes may be stored to and retrieved from the campaign database 144 to support comparison. Based on the perceived marketing value of this user (e.g., a close match of user attributes to desired attributes), competing bids may be placed on this ad impression by relevant advertisers.

The highest bidding advertiser may be allowed by the exchange server 150 to serve the ad placement. More specifically, the RTB engine 152 may route the ad creative to the publisher webpages 102, may inform the ad network server 140 of its winning bid, and may communicate the clearing price for the ad placement to facilitate payment. Alternatively, an ad network server 140 may respond to an ad request package with a signal indicating a decision not to bid on the impression. The RTB engine 152 may record information regarding winning bids, failed bids, and no bids (also referred to as passbacks) for the ad impression and may transmit that package to the soliciting publisher.

Continuing to refer to FIG. 1, a dynamic floor pricing system (DFPS) according to an embodiment of the present invention is now described in greater detail. The DFPS may include a publisher server 170 and a publisher workstation 180 that may be adapted to be used in connection with a network 160, such as the Internet, to position the publisher server 170 and publisher workstation 180 in data communication with a real-time bidding environment. More specifically, the publisher server 170 may comprise a DFPS engine 172 and a publishing database 174. The publisher workstation 180 may comprise system interface 182 that may access a DFPS client application 184 and also a sell-side RTB client application 182. A person of skill in the art appreciate that these components of a publisher server 170 and a publisher workstation 180 may reside on separate computing devices or, alternatively, may be collocated on a single computing device.

The publisher server 170 and the publisher workstation 180 may be connected to the network 160 via a server, a network interface device, or any other device capable of making such a connection. Alternatively, or in addition, the publisher server 170 and the publisher workstation 180 may be configured to be connected with the network 160 via a hotspot 120 that, for example, may employ a router connected to a link to a network. For example, and without limitation, the publisher server 170 and the publisher workstation 180 may be connected to the Internet by a wireless fidelity (WiFi) connection 155. The network interface device 120 may be any type of network interface device, including, without limitation, an Ethernet card and a wireless communication device such as an 802.11/WiFi network interface or a Wireless LAN device. The mobile network 190 may be any type of cellular network device, including GSM, GPRS, CDMA, EV-DO, EDGE, 3G, DECT, OFDMA, WIMAX, and LTE communication devices. These and other communication standards permitting connection to a network 160 may be supported within the invention. Moreover, other communication standards connecting the mobile device 110 with an intermediary device that is connected to the Internet, such as USB, FireWire, Thunderbolt, and any other digital communication standard may be supported by the invention.

The pricing, selection, and display functions of the dynamic floor pricing system (DFPS) will be described individually in greater detail below.

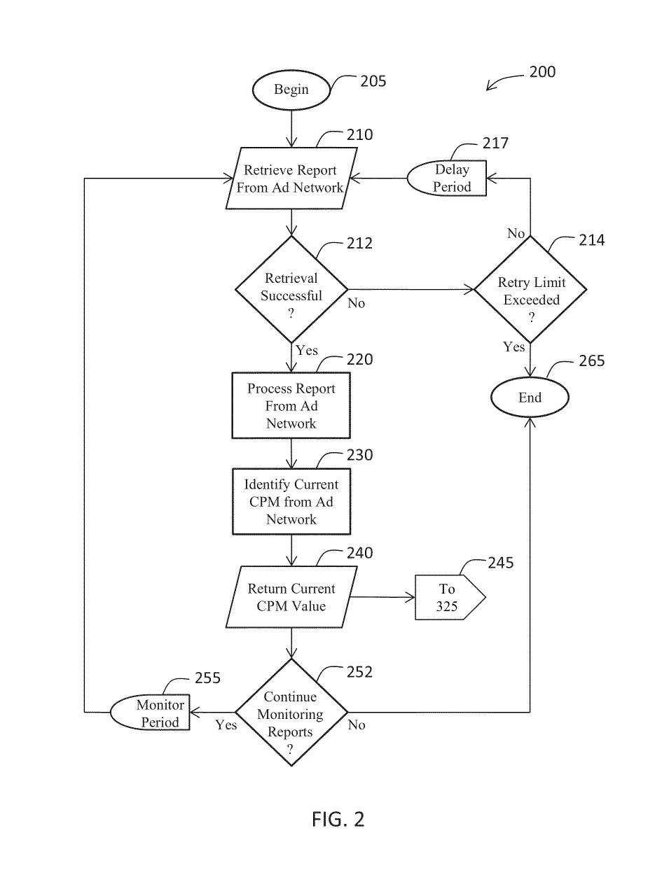

Referring now to flowchart 200 of FIG. 2 and continuing to refer to the block diagram of FIG. 1, the operation of the pricing function of the DFPS will be discussed in greater detail. More specifically, the relationship between the publisher server 170, the exchange server 150, and the ad networks servers 140, as well as the operational steps of determining true CPM value will now be discussed.

The following illustrative embodiment is included to provide clarity for one operational method that may be included within the scope of the present invention. A person of skill in the art will appreciate additional databases and operations that may be included within the DFPS of the present invention, which are intended to be included herein and without limitation. Also, the pricing function operation illustrated in flowchart 200 describes a method of interaction involving a single ad network. However, this method may be instantiated for any number of ad network servers simultaneously, and in a manner that generates results asynchronously.

From the start, the operation may begin at Block 205 where a report may be retrieved from an ad network server 140 (Block 210). For example, and without limitation, the ad network report containing information such as impression counts, revenue, and CPM may be routed to the publisher server 170 by the RTB engine 152 of the exchange server 150. The DPFS engine 172 of the publisher server 170 may store the ad network report to the publishing database 174. If at Block 212 the retrieval of the report from the ad network server 140 is successful, then the DFPS engine 172 may process the CPM-related data in the report (Block 220). For example, and without limitation, those fields that contain data that are significant to the calculation of a true CPM value may be culled from the report. For purposes of definition, the true CPM value may be determined through algorithmic post-processing designed to account for error in CPM values reported by an ad network. Detection of an unsuccessful attempt to retrieve a report at Block 212 may result in the DFPS attempting the retrieval operation again (Block 214). If the DFPS detects that a limit on the number of allowed retries is exceeded at Block 214, then the process 200 may end (Block 265). Otherwise, up to a limited number of retries (Block 214), the DPFS engine 172 may enforce a delay period (Block 217) in process 200 before attempting again to retrieve an ad network report from the ad network server 140 (Block 210). For example, and without limitation, the delay period may be set to the frequency at which the ad network' is monitored so as to give the remote ad network server 140 an opportunity to produce a fresh report that is readable by the DFPS.

At Block 230, the DFPS may analyze the pertinent data from the report communicated by the ad network server 140 to determine a true CPM value manifested during a target monitoring period. For example, and without limitation, the true CPM value may be computed as ad revenue per thousand impressions. Over-counting of impressions is a common problem, in that ad units often may not appear in a viewable space to a targeted user or may fail to fully load on the screen of the targeted user. To account for discrepancies identified in the impression count, total requests may be used instead of the actual monetized impressions to calculate the true CPM. Those of ordinary skill in the art will realize that the above embodiment of the present invention is only illustrative and is not intended to be limiting in any way. Other embodiments of algorithms for determining true CPM will readily suggest themselves to such skilled persons having the benefit of this disclosure.

Continuing to refer to flowchart 200 of FIG. 2, the true CPM value may be returned for further processing by other DFPS modules (Block 245), after which monitoring of the ad network server 140 for subsequent reports may continue (Block 252) in keeping with a prescribed monitoring period (Block 255). Alternatively, report monitoring may terminate at Block 252 and the process 200 may end at Block 265.

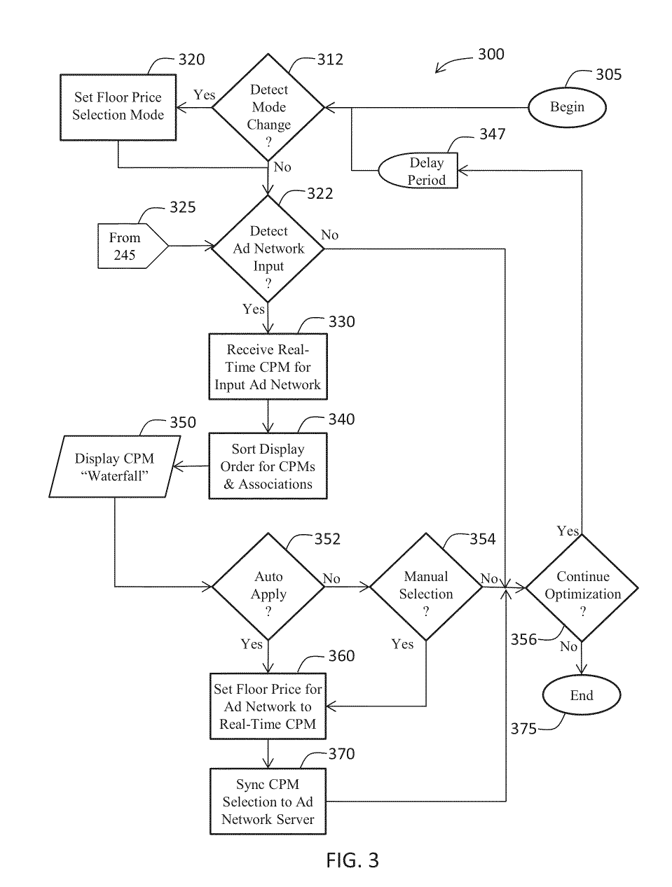

Referring now to flowchart 300 of FIG. 3 and continuing to refer to the block diagram of FIG. 1, the operation of the selection function of the DFPS will be discussed in greater detail. More specifically, the relationship between the publisher server 170, the publisher workstation 180, and the operational steps of selecting any number of dynamic price floors to be applied across one or more ad networks will now be discussed. The following illustrative embodiment is included to provide clarity for one operational method that may be included within the scope of the present invention. A person of skill in the art will appreciate additional databases and operations that may be included within the DFPS of the present invention, which are intended to be included herein and without limitation.

From the start (Block 305), the DFPS engine 172 may query the publishing database 174 on the publisher server 170 to ascertain the current floor price selection mode, and may compare that result to a mode selection setting at the DFPS client 184 on the publisher workstation 180. The possible states of the selection mode setting may include “manual” and “automatic.” Manual selection may mean that a dynamic floor price suggestion must be accepted by the publisher before it may be applied to the ad server for the associated ad network. Automatic may mean that the dynamic floor price is automatically applied for the associated ad network without prior confirmation by the publisher. If it is determined at Block 312 that the publisher has used the system interface 182 on the publisher workstation 180 to change the price floor selection mode, then the selection mode may be set accordingly in the publishing database 174 by the DFPS engine 172 at Block 320. Upon completion of Block 320, or if it is determined at Block 312 that the user does not desire to change selection mode, then at Block 322 the DFPS engine 172 may check for detection of ad network input (Block 325). For example, and without limitation, ad network input may include purchase data that may be captured during bidding events targeted to the particular ad impression for which a price floor modification may be in order. If no new ad network input is detected, a determination of whether to continue floor price optimization efforts for the ad network (Block 356). For example, and without limitation, the lack of impression counts, revenue, and/or CPM data from an ad network server 140 may be an event that causes the process to end at Block 375. In an alternative example, and without limitation, recognition of the lack of ad network data at Block 322 may be an event that triggers continuation of process 300 (Block 356) after the delay of processing for a prescribed time period (Block 347), after which fresh historical data may be expected to be generated by the ad network server 140 (Block 325).

Still referring to FIG. 3, if ad network input is detected by the DFPS engine 170 at Block 322, a real-time CPM value for the ad network of interest may be received from the input (Block 330) and stored in the publishing database 174. For example, and without limitation, an ad network may be of interest to the publisher if a current CPM value associated with the ad network is greater than an earlier-stored CPM value reported from the same ad network. Detection by the DFPS client on the publisher workstation 180 of any CPM value update may trigger sorting of the display order (Block 340) of all CPM values and their respective ad network associations. For example, and without limitation, the display order perceived by the publisher using the system interface 182 of the publisher workstation 180 may be represented as a “waterfall” of CPM values listed with the highest real-time CPM value at the top of the list and the lowest real-time CPM value at the bottom (Block 350).

Upon display of a new CPM value using the system interface 182 of the publisher workstation 180, the selection mode setting from the most recent execution of Block 320 for the associated ad network may determine how this new CPM value may influence the price floor. For example, and without limitation, if the selection mode setting is automatic (Block 352), then the price floor may be dynamically set to equal the real-time CPM value of the ad network. Alternatively, and also for example, without limitation, if the selection mode is not automatic (Block 352) but rather is manual (Block 354), the publisher may confirm intent to accept the real-time CPM value of the ad network as the new floor price (Block 360). In either selection mode scenario, the newly selected floor price may be communicated by the publisher server 170 to the ad network server 140 as input to future real-time bidding (Block 370). Whether the floor price has changed at Block 370, or the previously-recorded floor price has not changed after Block 354, the subsequent decision to continue floor price optimization may made at Block 356 as described above.

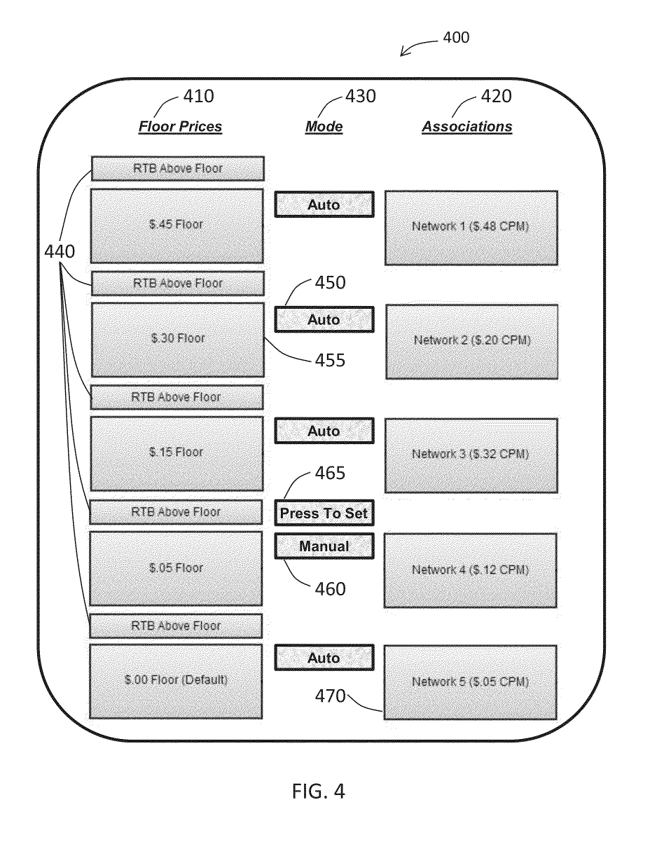

Referring now to the exemplary graphical user interface 400 of FIG. 4, the operation of the display function of the DFPS will be discussed in greater detail. More specifically, the relationship between the publisher server 170, the publisher workstation 180, and the operational steps of displaying and manipulating dynamic floor pricing selections will now be discussed. The following illustrative embodiment is included to provide clarity for one operational method that may be included within the scope of the present invention. A person of skill in the art will appreciate additional databases and operations that may be included within the DFPS of the present invention, which are intended to be included herein and without limitation.

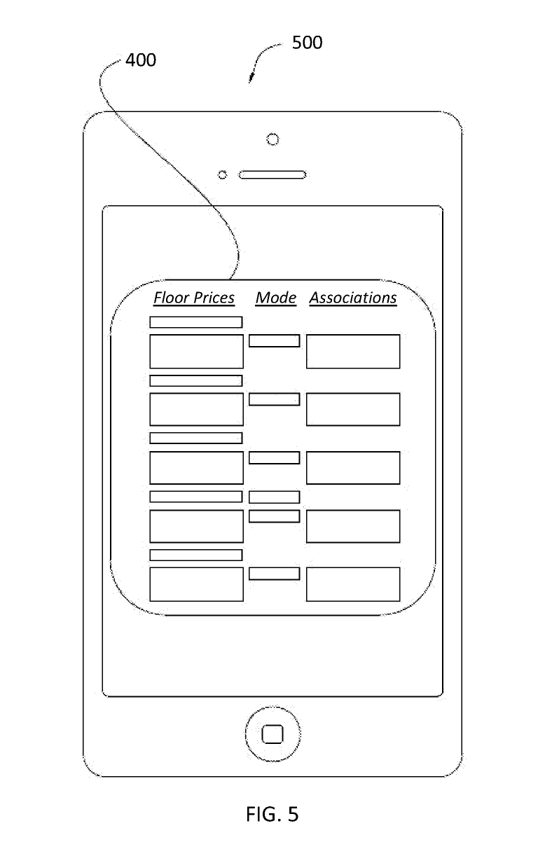

The DFPS client 184 may respond to detection of an ad network status update event recorded to the publishing database 174 by displaying, through the system interface 180, a column of CPM values 410 retrieved from each ad network server 140 of interest, a column of the associated ad network for each respective CPM value 420, and the current floor price selection mode setting 430 for each CPM-ad network association. Displayed adjacent to each CPM value, for visual comparison purposes, may be the currently active floor price setting 440 associated with each ad network. Referring additionally to graphical user interface 500 of FIG. 5, in an alternative embodiment, the DFPS interface of FIG. 4 may be displayed on a mobile device.

Continuing to refer to FIG. 4, for example, and without limitation, the RTB above floor CPM values 440 may be represented as a field displaying streaming updates received from the respective ad network servers 140 and recorded at preset delay intervals to the publishing database 174. Where a publisher has set the floor price selection mode to automatic 450, the floor price 455 for that ad network may change dynamically to match higher CPM values in the streaming updates. Alternatively, where a publisher has set the floor price selection mode to manual 460, the publisher may accept a displayed CPM value 440 as the new floor price for the ad network by choosing the “press to set” button 465. Also for example, and without limitation, the system interface 180 may allow the publisher to link an ad network tag 470 directly to one or more items (e.g., winning bid value) in the third-party network's most recent report. The system interface 182 may also use the DFPS client 184 to allow the individual network tags and their network associations to be dragged and dropped vertically within the displayed columns 410, 420, 430 to adjust floor price levels (e.g. dragging and dropping the $0.30 floor above $0.40 floor may adjust the $0.30 floor value to a higher-than $0.40 floor).

Embodiments of the present invention are described herein in the context of a system of computers, servers, and software. Those of ordinary skill in the art will realize that the embodiments of the present invention described above are provided as examples, and are not intended to be limiting in any way. Other embodiments of the present invention will readily suggest themselves to such skilled persons having the benefit of this disclosure.

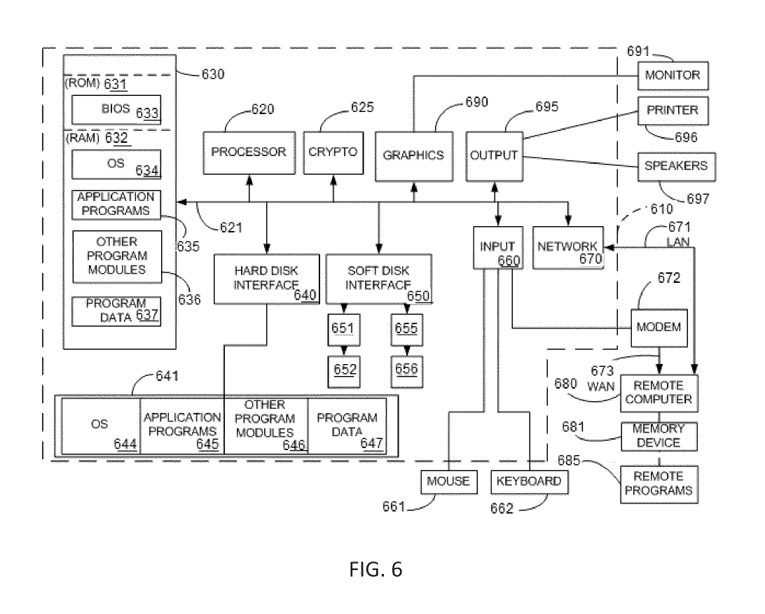

A skilled artisan will note that one or more of the aspects of the present invention may be performed on a computing device. The skilled artisan will also note that a computing device may be understood to be any device having a processor, memory unit, input, and output. This may include, but is not intended to be limited to, cellular phones, smart phones, tablet computers, laptop computers, desktop computers, personal digital assistants, etc. FIG. 6 illustrates a model computing device in the form of a computer 610, which is capable of performing one or more computer-implemented steps in practicing the method aspects of the present invention. Components of the computer 610 may include, but are not limited to, a processing unit 620, a system memory 630, and a system bus 621 that couples various system components including the system memory to the processing unit 620. The system bus 621 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI).

The computer 610 may also include a cryptographic unit 625. Briefly, the cryptographic unit 625 has a calculation function that may be used to verify digital signatures, calculate hashes, digitally sign hash values, and encrypt or decrypt data. The cryptographic unit 625 may also have a protected memory for storing keys and other secret data. In other embodiments, the functions of the cryptographic unit may be instantiated in software and run via the operating system.

A computer 610 typically includes a variety of computer readable media. Computer readable media can be any available media that can be accessed by a computer 610 and includes both volatile and nonvolatile media, removable and non-removable media. By way of example, and not limitation, computer readable media may include computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, FLASH memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by a computer 610. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared and other wireless media. Combinations of any of the above should also be included within the scope of computer readable media.

The system memory 630 includes computer storage media in the form of volatile and/or nonvolatile memory such as read only memory (ROM) 631 and random access memory (RAM) 632. A basic input/output system 633 (BIOS), containing the basic routines that help to transfer information between elements within computer 610, such as during start-up, is typically stored in ROM 631. RAM 632 typically contains data and/or program modules that are immediately accessible to and/or presently being operated on by processing unit 620. By way of example, and not limitation, FIG. 6 illustrates an operating system (OS) 634, application programs 635, other program modules 636, and program data 637.

The computer 610 may also include other removable/non-removable, volatile/nonvolatile computer storage media. By way of example only, FIG. 6 illustrates a hard disk drive 641 that reads from or writes to non-removable, nonvolatile magnetic media, a magnetic disk drive 651 that reads from or writes to a removable, nonvolatile magnetic disk 652, and an optical disk drive 655 that reads from or writes to a removable, nonvolatile optical disk 656 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 641 is typically connected to the system bus 621 through a non-removable memory interface such as interface 640, and magnetic disk drive 651 and optical disk drive 655 are typically connected to the system bus 621 by a removable memory interface, such as interface 650.

The drives, and their associated computer storage media discussed above and illustrated in FIG. 6, provide storage of computer readable instructions, data structures, program modules and other data for the computer 610. In FIG. 6, for example, hard disk drive 641 is illustrated as storing an OS 644, application programs 645, other program modules 646, and program data 647. Note that these components can either be the same as or different from OS 633, application programs 633, other program modules 636, and program data 637. The OS 644, application programs 645, other program modules 646, and program data 647 are given different numbers here to illustrate that, at a minimum, they may be different copies. A user may enter commands and information into the computer 610 through input devices such as a keyboard 662 and cursor control device 661, commonly referred to as a mouse, trackball or touch pad. Other input devices (not shown) may include a microphone, joystick, game pad, satellite dish, scanner, or the like. These and other input devices are often connected to the processing unit 620 through a user input interface 660 that is coupled to the system bus, but may be connected by other interface and bus structures, such as a parallel port, game port or a universal serial bus (USB). A monitor 691 or other type of display device is also connected to the system bus 621 via an interface, such as a graphics controller 690. In addition to the monitor, computers may also include other peripheral output devices such as speakers 697 and printer 696, which may be connected through an output peripheral interface 695.

The computer 610 may operate in a networked environment using logical connections to one or more remote computers, such as a remote computer 680. The remote computer 680 may be a personal computer, a server, a router, a network PC, a peer device or other common network node, and typically includes many or all of the elements described above relative to the computer 610, although only a memory storage device 681 has been illustrated in FIG. 6. The logical connections depicted in FIG. 6 include a local area network (LAN) 671 and a wide area network (WAN) 673, but may also include other networks 160. Such networking environments are commonplace in offices, enterprise-wide computer networks, intranets and the Internet.

When used in a LAN networking environment, the computer 610 is connected to the LAN 671 through a network interface or adapter 670. When used in a WAN networking environment, the computer 610 typically includes a modem 672 or other means for establishing communications over the WAN 673, such as the Internet. The modem 672, which may be internal or external, may be connected to the system bus 621 via the user input interface 660, or other appropriate mechanism. In a networked environment, program modules depicted relative to the computer 610, or portions thereof, may be stored in the remote memory storage device. By way of example, and not limitation, FIG. 6 illustrates remote application programs 685 as residing on memory device 681.

The communications connections 670 and 672 allow the device to communicate with other devices. The communications connections 670 and 672 are an example of communication media. The communication media typically embodies computer readable instructions, data structures, program modules or other data in a modulated data signal such as a carrier wave or other transport mechanism and includes any information delivery media. A “modulated data signal” may be a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Computer readable media may include both storage media and communication media.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

While the above description contains much specificity, these should not be construed as limitations on the scope of any embodiment, but as exemplifications of the presented embodiments thereof. Many other ramifications and variations are possible within the teachings of the various embodiments. While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the scope of the appended claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

Thus the scope of the invention should be determined by the appended claims and their legal equivalents, and not by the examples given.

That which is claimed is:

1. A computer implemented method for increasing publisher revenue for targeted online advertising, comprising:
retrieving, from an ad network, a buying report comprising purchase event data for an ad impression;
determining a true cost per thousand impressions (CPM) value from the buying report; and
setting a price floor associated with the ad network to equal the true CPM value;
wherein an ad request that is of a variable price type is characterized by the price floor.

2. The method according to claim 1 wherein the ad network defines a plurality of ad networks, and further comprising:
retrieving from each of the plurality of ad networks a respective buying report, wherein each buying report comprises purchase event data for a respective ad impression;
determining a respective true CPM value from each of the respective buying reports; and
setting a respective price floor associated with the plurality of ad networks to equal each of the respective true CPM values;
wherein the ad request is characterized by the respective price floor associated with each of the ad networks in the plurality of ad networks.

3. The method according to claim 1 wherein the step of retrieving the buying report further comprises triggering buying report retrieval at an end of a monitoring period.

4. The method according to claim 1 wherein the purchase event data includes a plurality of bid amounts comprising at least one winning bid amount; and wherein the step of determining the true CPM value further comprises determining the true CPM value using the plurality of bid amounts.

5. The method according to claim 4 wherein determining the true CPM value using the plurality of bid amounts further comprises averaging the plurality of bid amounts.

6. The method according to claim 4 wherein determining the true CPM value using the plurality of bid amounts further comprises selecting the at least one winning bid amount.

7. The method according to claim 2 wherein the purchase event data includes a plurality of purchase event records; and wherein determining the true CPM value from the buying report further comprises tallying an ad impression count using the plurality of purchase event records.

8. The method according to claim 7 wherein tallying the ad impression count further comprises counting the plurality of purchase event records.

9. The method according to claim 7 wherein tallying the ad impression count further comprises counting at least one monetized ad impression from the plurality of purchase event records.

10. The method according to claim 1 wherein setting the price floor associated with the ad network to equal the true CPM value further comprises automatically updating the price floor of the ad request to equal the true CPM value.

11. The method according to claim 1 wherein setting the price floor associated with the ad network to equal the true CPM value further comprises manually updating the price floor of the ad request to equal the true CPM value by:
displaying the true CPM value, and
receiving a command to apply the true CPM value.

12. The method according to claim 1 wherein the step of retrieving the buying report, the step of determining the true CPM value, and the step of setting the price floor are performed by a publisher server configured to be in data communication with the ad network.

13. A computer implemented method for increasing publisher revenue for targeted online advertising, comprising:
retrieving, from each of a plurality of ad networks, a respective buying report, wherein each of the respective buying reports comprises purchase event data for an ad impression, and wherein the purchase event data includes a plurality of bid amounts comprising at least one winning bid amount;
determining a respective true cost per thousand impressions (CPM) value from each of the respective buying reports using the plurality of bid amounts; and
setting a respective price floor associated with the ad network to equal the respective true CPM value;
wherein an ad request that is of a variable price type is characterized by the respective price floor;
wherein determining the true CPM values using the plurality of bid amounts further comprises at least one of averaging the plurality of bid amounts and selecting the at least one winning bid amount; and
wherein the price floor is at least one of automatically updated and manually updated;
wherein manually updating the price floor includes displaying the true CPM value and receiving a command to apply the true CPM value.

14. The method according to claim 13 wherein the step of retrieving the respective buying report further comprises triggering buying report retrieval at an end of a monitoring period.

15. The method according to claim 13 wherein the purchase event data includes a plurality of purchase event records; and wherein determining the true CPM value from each of the respective buying reports further comprises tallying an ad impression count using the plurality of purchase event records.

16. The method according to claim 15 wherein tallying the ad impression count further comprises counting the plurality of purchase event records.

17. The method according to claim 15 wherein tallying the ad impression count further comprises counting at least one monetized ad impression from the plurality of purchase event records.

18. A computer system for increasing publisher revenue for targeted online advertising, the system comprising at least one publisher server configured to
receive at least one buying report comprising purchase event data for an ad impression;
determine a true cost per thousand impressions (CPM) value from the at least one buying report; and
set a price floor to equal the true CPM value, wherein an ad request that is of a variable price type is characterized by the price floor.

19. The computer system according to claim 18 wherein the purchase event data includes a plurality of bid amounts comprising at least one winning bid amount, and wherein the at least one publisher server is further configured to
receive the at least one buying report at an end of a monitoring period; and
determine the true CPM value using the plurality of bid amounts.

20. The computer system according to claim 18 wherein the at least one publisher server is further configured to automatically update the price floor of the ad request to equal the true CPM value.

21. The computer system according to claim 18 further comprising at least one publisher workstation in communication with the at least one publisher server and configured to display the true CPM value, and to receive a command to apply the true CPM value; and wherein the at least one publisher server is further configured to selectively update the price floor of the ad request to equal the true CPM value upon receipt of the command.
